(19) United States
(12) Patent Application Publication
(10) Pub. No.: US 2017/0128922 A1
(43) Pub. Date: May 11, 2017

(54) Cold Start Catalyst and Its Use in Exhaust Systems

(71) Applicant: Johnson Matthey Public Limited Company, London (GB)

(72) Inventors: Hai-Ying CHEN, Wayne, PA (US); Shadab Mulla, Audubon, PA (US)

(21) Appl. No.: 15/412,830

(22) Filed: Jan. 23, 2017

Related U.S. Application Data
(63) Continuation of application No. 13/150,659, filed on Jun. 1, 2011.

(51) Int. Cl. B01J 29/76; B01D 53/94; B01J 23/63; B01J 35/04; B01J 29/46; B01J 23/42

(52) U.S. Cl. CPC B01J 29/7615; B01J 29/46; B01J 23/42; B01J 23/63; B01J 35/04; B01D 53/945; B01D 2255/1021; B01D 2255/1023; B01D 2255/2065; B01D 2255/20738; B01D 2255/2092; B01D 2255/502; B01D 2255/504; B01D 2255/9022; B01D 2255/91; B01D 2255/912

(57) ABSTRACT

A cold start catalyst is disclosed. The cold start catalyst comprises a zeolite catalyst and a supported platinum group metal catalyst. The zeolite catalyst comprises a base metal, a noble metal, and a zeolite. The supported platinum group metal catalyst comprises one or more platinum group metals and one or more inorganic oxide carriers. The invention also includes an exhaust system comprising the cold start catalyst. The cold start catalyst and the process result in improved NOₓ storage and NOₓ conversion, improved hydrocarbon storage and conversion, and improved CO oxidation through the cold start period.

### FIELD OF THE INVENTION

The invention relates to a cold start catalyst and its use in an exhaust system for internal combustion engines.

### BACKGROUND OF THE INVENTION

Internal combustion engines produce exhaust gases containing a variety of pollutants, including nitrogen oxides (“NOₓ”), carbon monoxide, and uncombusted hydrocarbons, which are the subject of governmental legislation. Emission control systems are widely utilized to reduce the amount of these pollutants emitted to atmosphere, and typically achieve very high efficiencies once they reach their operating temperature (typically, 200° C. and higher). However, these systems are relatively inefficient below their operating temperature, such as during the “cold start” period.

As even more stringent national and regional legislation lowers the amount of pollutants that can be emitted from diesel or gasoline engines, reducing emissions during the cold start period is becoming a major challenge. Thus, methods for reducing the level of NOₓ and hydrocarbons emitted during cold start condition continue to be explored.

For cold start hydrocarbon control, hydrocarbon trapping components based on zeolites have been investigated. In these systems, the zeolite adsorbs and stores hydrocarbons during the start-up period and releases the stored hydrocarbons when the exhaust temperature is high enough to desorb hydrocarbons. The desorbed hydrocarbons are subsequently converted when the downstream catalytic components reach their operating temperature.

For cold start NOₓ control, especially under lean-burn conditions, NOₓ storage and release catalysts have been studied. The catalysts adsorb NOₓ during the warm-up period and thermally desorb NOₓ at higher exhaust temperatures. Downstream catalysts, such as selective catalytic reduction (“SCR”) or NOₓ adsorber catalysts (“NAC”), effectively reduce the desorbed NOₓ to nitrogen.

Typically, NOₓ adsorbent materials consist of inorganic oxides such as alumina, silica, ceria, zirconia, titania, or mixed oxides which are coated with at least one platinum group metal. PCT Intl. Appl. WO 2008/047170 discloses a system wherein NOₓ from a lean exhaust gas is adsorbed at temperatures below 200° C. and is subsequently thermally desorbed above 200° C. The NOₓ adsorbent is taught to consist of palladium and a cerium oxide or a mixed oxide or composite oxide containing cerium and at least one other transition metal.

PCT Intl. Appl. WO 2004/076829 discloses an exhaust-gas purification system which includes a NOₓ storage catalyst arranged upstream of an SCR catalyst. The NOₓ storage catalyst includes at least one alkali, alkaline earth, or rare earth metal which is coated or activated with at least one platinum group metal (Pt, Pd, Rh, or Ir). A particularly preferred NOₓ storage catalyst is taught to include cerium oxide coated with platinum and additionally platinum as an oxidizing catalyst on a support based on aluminum oxide. EP 1027919 discloses a NOₓ adsorbent material that comprises a porous support material, such as alumina, zeolite, zirconia, titania, and/or lanthana, and at least 0.1 wt % precious metal (Pt, Pd, and/or Rh). Platinum carried on alumina is exemplified.

In addition, U.S. Pat. Nos. 5,656,244 and 5,800,793 describe systems combining a NOₓ storage/release catalyst with a three way catalyst. The NOₓ adsorbent is taught to comprise oxides of chromium, copper, nickel, manganese, molybdenum, or cobalt, in addition to other metals, which are supported on alumina, mullite, cordierite, or silicon carbide. PCT Intl. Appl. WO 03/056150 describes a system combining a low temperature NO₂ trap material and a soot filter. The low temperature NO₂ trap material is taught to comprise of zeolites exchanged with base metal cations, with the zeolites selected from ZSM-5, ETS-10, Y-zeolite, beta zeolite, ferrierite, mordenite, titanium silicates and aluminum phosphates and the base metals selected from Mn, Cu, Fe, Co, W, Re, Sn, Ag, Zn, Mg, Li, Na, K, Cs, Nd and Pr.

Unfortunately, the NOₓ adsorption capacity of such systems is not high enough especially at high NOₓ storage efficiency. Because of increasing stringent global legislation regulating the amount of NOₓ and hydrocarbons released to the atmosphere from internal combustion engines, the need for more effective exhaust gas cleaning during cold start conditions is always present.

As with any automotive system and process, it is desirable to attain still further improvements in exhaust gas treatment systems, particularly under cold start conditions. We have discovered a new cold start catalyst that provides enhanced cleaning of the exhaust gases from internal combustion engines.

### SUMMARY OF THE INVENTION

The invention is a cold start catalyst for use in an exhaust system. The cold start catalyst comprises a zeolite catalyst and a supported platinum group metal catalyst. The zeolite catalyst comprises a base metal, a noble metal, and a zeolite. The supported platinum group metal catalyst comprises one or more platinum group metals and one or more inorganic oxide carriers. The invention also includes an exhaust system comprising the cold start catalyst. The cold start catalyst effectively reduces emissions during the cold start period through improved NOₓ storage and NOₓ conversion, improved hydrocarbon storage and conversion, and improved CO oxidation.

### DETAILED DESCRIPTION OF THE INVENTION

The cold start catalyst of the invention comprises a zeolite catalyst and a supported platinum group metal catalyst. The zeolite catalyst comprises a base metal, a noble metal, and a zeolite. The base metal is preferably iron, copper, manganese, chromium, cobalt, nickel, tin, or mixtures thereof; more preferably, iron, copper, manganese, cobalt, or mixtures thereof. Iron is particularly preferred. The noble metal is preferably palladium, platinum, rhodium, silver, or mixtures thereof; more preferably, palladium, platinum, rhodium, or mixtures thereof. Palladium is particularly preferred.

The zeolite may be any natural or a synthetic zeolite, including molecular sieves, and is preferably composed of aluminum, silicon, and/or phosphorus. The zeolites typically have a three-dimensional arrangement of SiO₄, AlO₄, and/or PO₄ that are joined by the sharing of oxygen atoms. The zeolite frameworks are typically anionic, which are counterbalanced by charge compensating cations, typically alkali and alkaline earth elements (e.g., Na, K, Mg, Ca, Sr, and Ba) and also protons. Other metals (e.g., Fe, Ti, and Ga) may be incorporated into the framework of the zeolite to produce a metal-incorporated zeolite. For instance, iron may be substituted for aluminum in the framework of beta zeolite to produce an iron-beta zeolite (Fe-β zeolite).

The zeolite is preferably a beta zeolite, a faujasite (such as an X-zeolite or a Y-zeolite, including NaY and USY), an L-zeolite, a ZSM zeolite (e.g., ZSM-5, ZSM-48), an SSZ-zeolite (e.g., SSZ-13, SSZ-41, SSZ-33), a mordenite, a chabazite, an offretite, an erionite, a clinoptilolite, a silicalite, an aluminum phosphate zeolite (including metalloaluminophosphates such as SAPO-34), a mesoporous zeolite (e.g., MCM-41, MCM-49, SBA-15), a metal-incorporated zeolite, or mixtures thereof; more preferably, the zeolites are beta zeolite, ZSM-5 zeolite, Fe-β zeolite, or SSZ-33, or Y-zeolite. The zeolite is most preferably beta zeolite, ZSM-5 zeolite, Fe-β zeolite, or SSZ-33.

The zeolite catalyst may be prepared by any known means. For instance, the base metal and noble metal may be added to the zeolite to form the zeolite catalyst by any known means, the manner of addition is not considered to be particularly critical. For example, a noble metal compound (such as palladium nitrate) and a base metal compound (such as iron nitrate) may be supported on the zeolite by impregnation, adsorption, ion-exchange, incipient wetness, precipitation, or the like. The noble metal compound and a base metal compound may be added to the zeolite simultaneously in one step, or sequentially in two or more steps.

The supported platinum group metal catalyst comprises one or more platinum group metals (“PGM”) and one or more inorganic oxide carriers. The PGM may be platinum, palladium, rhodium, iridium, or combinations thereof, and most preferably platinum and/or palladium. The inorganic oxide carriers most commonly include oxides of Groups 2, 3, 4, 5, 13 and 14 elements. Useful inorganic oxide carriers preferably have surface areas in the range 10 to 700 m²/g, pore volumes in the range 0.1 to 4 mL/g, and pore diameters from about 10 to 1000 Angstroms. The inorganic oxide carrier is preferably alumina, silica, titania, zirconia, ceria, niobia, tantalum oxides, molybdenum oxides, tungsten oxides, or mixed oxides or composite oxides of any two or more thereof, e.g. silica-alumina, ceria-zirconia or alumina-ceria-zirconia. Alumina and ceria are particularly preferred.

The supported platinum group metal catalyst may be prepared by any known means. Preferably, the one or more platinum group metals are loaded onto the one or more inorganic oxides by any known means to form the supported PGM catalyst, the manner of addition is not considered to be particularly critical. For example, a platinum compound (such as platinum nitrate) may be supported on an inorganic oxide by impregnation, adsorption, ion-exchange, incipient wetness, precipitation, or the like. Other metals may also be added to the supported PGM catalyst.

The cold start catalyst of the present invention may be prepared by processes well known in the prior art. The zeolite catalyst and the supported platinum group metal catalyst may be physically mixed to produce the cold start catalyst. Preferably, the cold start catalyst further comprises a flow-through substrate or filter substrate. In one embodiment, the zeolite catalyst and the supported platinum group metal catalyst are coated onto the flow-through or filter substrate, and preferably deposited on the flow-through or filter substrate using a washcoat procedure to produce a cold start catalyst system.

The flow-through or filter substrate is a substrate that is capable of containing catalyst components. The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates, metallo aluminosilicates (such as cordierite and spudomene), or a mixture or mixed oxide of any two or more thereof. Cordierite, a magnesium aluminosilicate, and silicon carbide are particularly preferred.

The metallic substrates may be made of any suitable metal, and in particular heat-resistant metals and metal alloys such as titanium and stainless steel as well as ferritic alloys containing iron, nickel, chromium, and/or aluminum in addition to other trace metals.

The flow-through substrate is preferably a flow-through monolith having a honeycomb structure with many small, parallel thin-walled channels running axially through the substrate and extending throughout from an inlet or an outlet of the substrate. The channel cross-section of the substrate may be any shape, but is preferably square, sinusoidal, triangular, rectangular, hexagonal, trapezoidal, circular, or oval.

The filter substrate is preferably a wall-flow monolith filter. The channels of a wall-flow filter are alternately blocked, which allow the exhaust gas stream to enter a channel from the inlet, then flow through the channel walls, and exit the filter from a different channel leading to the outlet. Particulates in the exhaust gas stream are thus trapped in the filter.

The zeolite catalyst and the supported platinum group catalyst may be added to the flow-through or filter substrate by any known means. A representative process for preparing the cold start catalyst using a washcoat procedure is set forth below. It will be understood that the process below can be varied according to different embodiments of the invention. Also, the order of addition of the zeolite catalyst and the supported PGM catalyst onto the flow-through or filter substrate is not considered critical. Thus, the zeolite catalyst may be washcoated on the substrate prior to the supported PGM catalyst or the supported PGM catalyst may be washcoated on the substrate prior to the zeolite catalyst.

The pre-formed zeolite catalyst may be added to the flow-through or filter substrate by a washcoating step. Alternatively, the zeolite catalyst may be formed on the flow-through or filter substrate by first washcoating unmodified zeolite, a noble metal/zeolite or a base metal/zeolite onto the substrate to produce a zeolite-coated substrate. Noble metal and/or base metal may then be added to the zeolite-coated substrate, which may be accomplished by an impregnation procedure, or the like

The washcoating procedure is preferably performed by first slurrying finely divided particles of the zeolite catalyst (or base metal/zeolite or noble metal/zeolite or unmodified zeolite) in an appropriate solvent, preferably water, to form the slurry. Additional components, such as transition metal oxides, binders, stabilizers, or promoters may also be incorporated in the slurry as a mixture of water soluble or water-dispersible compounds. The slurry preferably contains between 10 to 70 weight percent solids, more preferably between 30 to 50 weight percent. Prior to forming the slurry, the zeolite catalyst (or base metal/zeolite, noble metal/zeolite, or unmodified zeolite) particles are preferably subject to a size reduction treatment (e.g., milling) such that the average particle size of the solid particles is less than 20 microns in diameter.

The flow-through or filter substrate may then be dipped one or more times into the slurry or the slurry may be coated on the substrate such that there will be deposited on the substrate the desired loading of catalytic materials. If noble metal and/or base metal are not incorporated into the zeolite prior to washcoating the flow-through or filter substrate, the zeolite-coated substrate is typically dried and calcined and then, the noble metal and/or base metal may be added to the zeolite-coated substrate by any known means, including impregnation, adsorption, or ion-exchange, for example, with a noble metal compound (such as palladium nitrate) and/or a base metal compound (such as iron nitrate). Preferably, the entire length of the flow-through or filter substrate is coated with the slurry so that a washcoat of the zeolite catalyst covers the entire surface of the substrate.

After the flow-through or filter substrate has been coated with the zeolite catalyst slurry, and impregnated with noble metal and base metal if necessary, the coated substrate is preferably dried and then calcined by heating at an elevated temperature to form the zeolite catalyst-coated substrate. Preferably, the calcination occurs at 400 to 600° C. for approximately 1 to 8 hours.

The washcoat addition of the supported PGM catalyst is preferably accomplished by first preparing a slurry of finely divided particles of the supported PGM catalyst in an appropriate solvent, preferably water. Prior to forming the slurry, the supported PGM catalyst particles are preferably subject to a size reduction treatment (e.g., milling) such that the average particle size of the solid particles is less than 20 microns in diameter. Additional components, such as transition metal oxides, binders, stabilizers, or promoters may be incorporated in the slurry as a mixture of water-dispersible or soluble compounds.

The zeolite catalyst-coated substrate may then be dipped one or more times in the supported PGM catalyst slurry or the supported PGM catalyst slurry may be coated on the zeolite catalyst-coated substrate such that there will be deposited on the substrate the desired loading of catalytic materials.

Alternatively, a slurry containing only the inorganic oxide(s) may first be deposited on the zeolite catalyst-coated substrate to form an inorganic oxide-coated substrate, followed by drying and calcination steps. The platinum group metal(s) may then be added to the inorganic oxide-coated substrate by any known means, including impregnation, adsorption, or ion-exchange of a platinum group metal compound (such as platinum nitrate).

Preferably, the entire length of the flow-through or filter substrate is coated with the supported PGM catalyst slurry so that a washcoat of the supported PGM catalyst covers the entire surface of the substrate.

After the flow-though or filter substrate has been coated with the supported PGM catalyst slurry, it is preferably dried and then calcined by heating at an elevated temperature to produce the cold start catalyst. Preferably, the calcination occurs at 400 to 600° C. for approximately 1 to 8 hours.

In an alternative embodiment, the flow-through or filter substrate is comprised of the zeolite catalyst, and the supported platinum group metal catalyst is coated onto the zeolite catalyst substrate. In this case, the zeolite is extruded to form the flow-through or filter substrate, and is preferably extruded to form a honeycomb flow-through monolith. Extruded zeolite substrates and honeycomb bodies, and processes for making them, are known in the art. See, for example, U.S. Pat. Nos. 5,492,883, 5,565,394, and 5,633,217 and U.S. Pat. No. Re. 34,804. Typically, the zeolite material is mixed with a permanent binder such as silicone resin and a temporary binder such as methylcellulose, and the mixture is extruded to form a green honeycomb body, which is then calcined and sintered to form the final zeolite flow-through monolith. The zeolite may contain noble metal and/or base metal prior to extruding such that a noble metal/zeolite, base metal/zeolite, or noble metal-base metal/zeolite flow-through monolith is produced by the extrusion procedure.

If a zeolite flow-through monolith is formed, the zeolite monolith is then subjected to an impregnation procedure if necessary to load noble metal and/or base metal to the zeolite monolith, followed by a washcoating step to washcoat the supported PGM catalyst.

The invention also includes an exhaust system for internal combustion engines comprising the cold start catalyst. The exhaust system preferably comprises one or more additional after-treatment devices capable of removing pollutants from internal combustion engine exhaust gases at normal operating temperatures. Preferably, the exhaust system comprises the cold start catalyst and: (1) a selective catalytic reduction system; (2) a particulate filter; (3) a selective catalytic reduction filter system; (4) a NOₓ adsorber catalyst; (5) a three-way catalyst system; or any combination thereof.

These after-treatment devices are well known in the art. Selective catalytic reduction (SCR) systems are devices that reduce NOₓ to N₂ by reaction with nitrogen compounds (such as ammonia or urea) or hydrocarbons (lean NOₓ reduction). A typical SCR catalyst is comprised of a vanadia-titania catalyst, a vanadia-tungsta-titania catalyst, or a metal/zeolite catalyst such as iron/beta zeolite, copper/beta zeolite, copper/SSZ-13, copper/SAPO-34, Fe/ZSM-5, or copper/ZSM-5.

Particulate filters are devices that reduce particulates from the exhaust of internal combustion engines. Particulate filters include catalyzed particulate filters and bare (non-catalyzed) particulate filters. Catalyzed particulate filters (for diesel and gasoline applications) include metal and metal oxide components (such as Pt, Pd, Fe, Mn, Cu, and ceria) to oxidize hydrocarbons and carbon monoxide in addition to destroying soot trapped by the filter.

Selective catalytic reduction filters (SCRF) are single-substrate devices that combine the functionality of an SCR and particulate filter. They are used to reduce NOₓ and particulate emissions from internal combustion engines.

NOₓ adsorber catalysts (NACs) are designed to adsorb NOₓ under lean exhaust conditions, release the adsorbed NOₓ under rich conditions, and reduce the released NOₓ to form N₂. NACs typically include a NON-storage component (e.g., Ba, Ca, Sr, Mg, K, Na, Li, Cs, La, Y, Pr, and Nd), an oxidation component (preferably Pt) and a reduction component (preferably Rh). These components are contained on one or more supports.

Three-way catalyst systems (TWCs) are typically used in gasoline engines under stoichiometric conditions in order to convert NOₓ to N₂, carbon monoxide to CO₂, and hydrocarbons to CO₂ and H₂O on a single device.

The exhaust system can be configured so that the cold start catalyst is located close to the engine and the additional after-treatment device(s) are located downstream of the cold start catalyst. Thus, under normal operating conditions, engine exhaust gas first flows through the cold start catalyst prior to contacting the after-treatment device(s). Alternatively, the exhaust system may contain valves or other gas-directing means such that during the cold-start period (below a temperature ranging from about 150 to 220° C., as measured at the after-treatment device(s)), the exhaust gas is directed to contact the after-treatment device(s) before flowing to the cold start catalyst. Once the after-treatment device(s) reaches the operating temperature (about 150 to 220° C., as measured at the after-treatment device(s)), the exhaust gas flow is then redirected to contact the cold start catalyst prior to contacting the after-treatment device(s). This ensures that the temperature of the cold start catalyst remains low for a longer period of time, and thus improves efficiency of the cold start catalyst, while simultaneously allowing the after-treatment device(s) to more quickly reach operating temperature. U.S. Pat. No. 5,656,244, the teachings of which are incorporated herein by reference, for example, teaches means for controlling the flow of the exhaust gas during cold-start and normal operating conditions.

The following examples merely illustrate the invention. Those skilled in the art will recognize many variations that are within the spirit of the invention and scope of the claims.

### Example 1: Preparation of Catalysts of the Invention

Catalyst 1A: Pd—Fe/Beta Zeolite+Pt/Al₂O₃

Beta zeolite is added to an aqueous iron nitrate, followed by silica binder to form a slurry. The slurry is coated on a flow-through cordierite substrate to achieve an iron loading of 190 g/ft³ Fe, and the Fe/zeolite-coated substrate is dried, and then calcined by heating at 500° C. for 4 hours. Palladium is then added to the Fe/zeolite-coated substrate by impregnation of an aqueous Pd nitrate solution to achieve a Pd loading of 50 g/ft³, and the Pd—Fe/zeolite-coated substrate is dried and then calcined by heating at 500° C. for 4 hours.

Platinum nitrate is added to a water slurry of alumina particles (milled to an average particle size of less than 10 microns in diameter) to form a Pt/alumina catalyst slurry. The Pt/alumina catalyst slurry is then coated on the Pd—Fe/zeolite-coated substrate to achieve a Pt loading of 50 g/ft³, and the final coated substrate is dried, and then calcined by heating at 500° C. for 4 hours to produce Catalyst 1A (containing 50 g/ft³ Pd, 190 g/ft³ Fe, and 50 g/ft³ Pt).

Catalyst 1B: Pd—Fe/Beta Zeolite+Pt/Al₂O₃+Pd/CeO₂

Catalyst 1B is prepared by adding a Pd/ceria component to the finished Catalyst 1A. Palladium/ceria is prepared by the incipient wetness of palladium nitrate onto ceria, followed by drying and calcining at 500° C. for 2 hours. The Pd/ceria is then milled to an average particle size of less than 10 microns in diameter, and added to water to form a slurry. The Pd/ceria slurry and the Pt/alumina slurry from the Catalyst 1A preparation are coated on the Pd—Fe/zeolite-coated substrate from the Catalyst 1A preparation to achieve a Pd loading of 50 g/ft³, and the final coated substrate is dried, and then calcined by heating at 500° C. for 4 hours to produce Catalyst 1B (containing 50 g/ft³ Pd and 190 g/ft³ Fe on zeolite; 50 g/ft³ Pt on alumina; and 50 g/ft³ Pd on ceria).

Catalyst 1C: Pd—Fe on Extruded Beta Zeolite+Pd/CeO₂+Pt/Al₂O₃

A beta zeolite monolith (formed by extruding beta zeolite into a honeycomb monolith; see, e.g., U.S. Pat. Nos. 5,492,883, 5,565,394, and 5,633,217) is impregnated with an aqueous iron nitrate solution, followed by drying, and calcining by heating at 500° C. for 4 hours to achieve a Fe loading of 800 g/ft³; and then impregnated with a palladium nitrate solution, followed by drying, and calcining at 500° C. for 4 hours to achieve a Pd loading of 50 g/ft³.

The Fe—Pd/zeolite monolith is then coated with a supported PGM catalyst in two washcoat steps as follows. Pd/ceria (prepared as in Catalyst 1B) and alumina particles are separately milled to an average particle size of less than 10 microns in diameter, and are added to water to form a slurry. The Pd/ceria and alumina slurry is then coated onto the Fe—Pd/zeolite monolith to achieve a Pd loading of 40 g/ft³, and the coated substrate is dried, and then calcined by heating at 500° C. for 4 hours. The substrate is then washcoated with a supported Pt/alumina catalyst as in Catalyst 1A, dried, and then calcined to produce Catalyst 1C (containing 50 g/ft³ Pd, 800 g/ft³ Fe on extruded zeolite; 40 g/ft³ Pd on ceria; and 50 g/ft³ Pt on alumina).

Catalyst 1D: Pd—Fe/ZSM5+Pt/Al₂O₃

The procedure of Catalyst 1A is repeated, with the exception that an iron-containing ZSM5 zeolite (7 wt. % Fe₂O₃) is used in place of Fe/beta zeolite to produce Catalyst 1D (containing 50 g/ft³ Pd, 170 g/ft³ Fe on zeolite; and 50 g/ft³ Pt on alumina).

Catalyst 1E: Pd Supported on Fe-β Zeolite+Pt/Al₂O₃

The procedure of Catalyst 1A is repeated, with the exception that an iron-incorporated beta zeolite (Fe-β zeolite in which the Al atoms have been substituted by Fe) is used in place of Fe/beta zeolite to produce Catalyst 1E (containing 50 g/ft³ Pd, 250 g/ft³ Fe from the zeolite; and 50 g/ft³ Pt on alumina).

### Example 2: Comparative Catalyst Preparation

Comparative Catalyst 2A: Pt/Al₂O₃+Pd/CeO₂

Comparative Catalyst 2A is a conventional catalyst for cold start NOₓ control, similar to the layered system disclosed in WO 2008/047170. It is prepared according to the procedure of Catalyst 1C, with the exception that the coating is performed on a flow-through cordierite substrate, the Pd—Fe on extruded beta zeolite is not included, and the Pd and Pt loadings are also increased. Comparative Catalyst 2A contains 100 g/ft³ Pd on Pd/ceria and 100 g/ft³ Pt on Pt/alumina.

Comparative Catalyst 2B: Pd—Pt/Al₂O₃+Beta Zeolite+Pt/Al₂O₃

Comparative Catalyst 2B is a typical diesel oxidation catalyst that contains zeolite as a hydrocarbon trapping component. It is prepared as follows.

Platinum nitrate and palladium nitrate are added to a water slurry of alumina particles (milled to an average particle size of less than 10 microns in diameter), followed by the addition of the beta zeolite to the slurry. The Pt—Pd/alumina and beta zeolite slurry is then coated on a flow-through cordierite substrate to achieve a Pt loading of 17.5 g/ft³ and a Pd loading of 35 g/ft³, and coated substrate is dried, and then calcined at 500° C. for 4 hours.

The zeolite monolith is then washcoated with a supported PGM catalyst as in the procedure of Catalyst 1A to result in a second washcoat Pt loading of 52.5 g/ft³. The substrate is dried and then calcined to produce Comparative Catalyst 2B, containing 70 g/ft³ Pt and 35 g/ft³ Pd.

### Example 3: Testing Procedures

All the catalysts are tested on core samples (2.54 cm×8.4 cm) of the flow-through catalyst-coated cordierite substrate. Catalyst cores are first aged under flow-through conditions in a furnace under hydrothermal conditions (5% H₂O, balance air) at 750° C. for 16 hours. The cores are then tested for catalytic activity in a laboratory reactor, using a feed gas stream that is prepared by adjusting the mass flow of the individual exhaust gas components. The gas flow rate is maintained at 21.2 L min⁻¹ resulting in a Gas Hourly Space Velocity of 30,000 h⁻¹ (GHSV=30,000 h⁻¹).

The catalysts are tested under lean conditions, using a synthetic exhaust gas feed stream consisting of 200 ppm NO, 200 ppm CO, 500 ppm decane (on C₁ basis), 10% O₂, 5% CO₂, 5% H₂O and the balance nitrogen (volume %). The catalyst is exposed to the feed gas stream, first at an isothermal inlet gas temperature of 80° C. for 100 seconds, following which the inlet gas temperature is increased linearly with time at 100° C./min.

Catalyst 1C is also tested under stoichiometric conditions, using a synthetic gas composition consisting of 2000 ppm NO, 1% CO, 0.33% H₂, 600 ppm propane (on C₁ basis), 600 ppm propene (on C₁ basis), 0.76% O₂, 14% CO₂, 10% H₂O and the balance nitrogen (volume %). The catalyst is exposed to the synthetic gas stream, first at an isothermal inlet gas temperature of 80° C. for 100 seconds, following which the inlet gas temperature is increased linearly with time at 100° C./min. Thus, the catalyst is exposed to the synthetic gas stream at 80° C. for the first 100 seconds of testing and the temperature exceeds 200° C. after the first 172 seconds of testing.

The results at Table 1 show that the catalysts of the invention (1A-1E) demonstrate much higher NOₓ storage capacity at low temperature (80° C. for first 100 seconds of testing) and typically a higher NOₓ storage capacity below 200° C. (i.e., about the first 172 seconds of testing) when exposed to a synthetic lean gas stream, as compared to Comparative Catalysts 2A and 2B. Both Comparative Catalysts 2A and 2B show an instantaneous, sharp NOₓ slip at catalyst outlet, indicating negligible NOₓ storage at lower temperatures. The total NOₓ storage capacity below 200° C. represents the amount of NOₓ stored below this temperature and the amount of NOₓ that may have been converted (at least partially) by the catalyst during the temperature increase to 200° C. Thus, the total NOₓ storage capacity below 200° C. represents the NOₓ that has either been converted (at least partially) by the catalyst during the temperature increase to 200° C. or can be subsequently released by the catalyst at temperatures greater than 200° C. and then converted by a downstream NOₓ reduction catalyst, as they would have reached their operating window.

Despite the fact that Catalyst 1A has only half the PGM loading of Comparative Catalyst 2A and a comparable total PGM loading to Comparative Catalyst 2B, Catalyst 1A effectively stores significantly higher amounts of NOₓ under cold start conditions, suggesting the added benefit of the presence of base metal and noble metal on the zeolite. A further significant increase in the cold start NOₓ storage is achieved with Catalysts 1B, where Pd is also supported on ceria in addition to the zeolite, and Catalyst 1C, where the zeolite is extruded as a substrate body and still provides high NOₓ storage capacity. Catalysts 1D and 1E show that ZSM-5 and an iron-incorporated beta zeolite (Fe-β zeolite) can also be used for NOₓ storage under cold-start conditions.

The catalysts of the invention also effectively store hydrocarbons during the cold start phase. At temperatures below 150° C., Catalysts 1A, 1B and 1C store a similar amount of hydrocarbon (HC) as Comparative Catalysts 2A and 2B. For example, the amount of hydrocarbon stored in 100 seconds at 80° C. was about 0.29 g CH₄/L of catalysts for Catalysts 1A-1C and Comparative Catalysts 2A and 2B. At temperatures greater than 150° C., a significantly higher HC slip is obtained for Comparative Catalysts 2A and 2B compared to Catalysts 1A, 1B, and 1C. See Table 2. The peak hydrocarbon concentration resulting from testing of Comparative Catalysts 2A and 2B (greater than 100 ppm) is twice as much as that obtained for Catalysts 1A, 1B, and 1C (about 50 ppm), suggesting that the catalysts of the invention not only effectively store hydrocarbons during the cold start, but also convert the stored hydrocarbons more effectively when the temperature is increased.

The catalysts of the invention also exhibit lower selectivity to N₂O during the cold start phase. At temperatures below 150° C., Catalysts 1A, 1B and 1C and Comparative Catalysts 2A and 2B all show no production of N₂O. Above 150° C., N₂O is detected for all catalysts. However, Table 2 also shows that only low levels of N₂O form over Catalysts 1A, 1B, and 1C, as indicated by the peak N₂O concentration released during the warm-up. In contrast, a significantly higher amount of N₂O is detected over the two comparative catalysts. These results indicate that the catalysts of the invention exhibit higher selectivity to N₂.

Besides cold start NOₓ and HC control, Catalysts 1A-1C also unexpectedly exhibit improved CO oxidation activity. As seen in Table 3, Catalysts 1A-1C show a significantly lower temperature to achieve 90% CO conversion during the warm-up (“T90”) as compared to Comparative Catalyst 2B, a typical diesel oxidation catalyst. Because the amount of PGM affects the CO oxidation activity, Comparative Catalyst 2A having a significantly higher amount of PGM expectedly has the lowest T90.

In addition, once the catalysts of the invention reach the operating temperature (e.g. >200° C.), Catalysts 1A-1C all show comparable NO to NO₂ oxidation activity to Comparative Catalyst 2B. This is shown in Table 4 by the ratio of NO₂ formed to the total NOₓ at 400° C. inlet gas temperature. Note, once again, that Comparative Catalyst 2A has a higher Pt loading (100 g/ft³) compared to Catalysts 1A, 1B, 1C (50 g/ft³) or Comparative Catalyst 2B (70 g/ft³) explaining its relatively higher CO and NO oxidation activity.

In addition to their capabilities under lean operating conditions, Catalyst 1C also demonstrates good NOₓ and hydrocarbon storage capacity for cold start conditions as well as good CO oxidation activity, when tested under stoichiometric conditions, as shown in Table 5.

In summary, the cold start catalyst system of the invention performs multiple functions, including (1) low temperature NOₓ storage and conversion with high selectivity to N₂; (2) low temperature hydrocarbon storage and conversion; (3) improved CO oxidation activity; and (4) comparable NO to NO₂ oxidation activity after warm-up.

TABLE 1
NOₓ Storage Capacity Results

| | NOₓ storage Capacity at | Total NOₓ Storage Capacity below |
|---|---|---|
| Catalyst | 80° C. (g NO₂/L) | 200° C.(g NO₂/L) |
| 1A | 0.20 | 0.21 |
| 1B | 0.32 | 0.47 |
| 1C | 0.29 | 0.44 |
| 1D | 0.14 | (nm) |
| 1E | 0.17 | (nm) |
| 2A * | 0.13 | 0.30 |
| 2B * | 0.02 | 0.06 |

* Comparative Example
(nm) = not measured

TABLE 2
Hydrocarbon (HC) and N₂O Release above 150° C.

| | Peak HC concentration during | Peak N₂O concentration during |
|---|---|---|
| Catalyst | warm-up (ppm) | warm-up (ppm) |
| 1A | 53 | 28 |
| 1B | 49 | 20 |
| 1C | 56 | 31 |
| 2A * | 119 | 126 |
| 2B * | 108 | 74 |

* Comparative Example

TABLE 3
Temperature for 90% CO conversion (T90) during Warm-up

| Catalyst | T90 (° C.) |
|---|---|
| 1A | 145 |
| 1B | 154 |
| 1C | 150 |
| 2A * | 102 |
| 2B * | 219 |

* Comparative Example

TABLE 4
NO₂/NOₓ ratio at 400° C.

| Catalyst | NO₂/NOₓ |
|---|---|
| 1A | 0.63 |
| 1B | 0.62 |
| 1C | 0.74 |
| 2A * | 0.89 |
| 2B * | 0.73 |

* Comparative Example

TABLE 5
Performance of Catalyst 1C under Stoichiometric Conditions

| NOₓ storage | Total NOₓ Storage | HC storage | T90 for CO |
|---|---|---|---|
| Capacity at | Capacity below | Capacity at | conversion |
| 80° C. (g NO₂/L) | 200° C.(g NO₂/L) | 80° C. (g CH₄/L) | (° C.) |
| 0.33 | 0.39 | 0.19 | 202 |

We claim:

1. A catalyst article for treating exhaust gas comprising:
a. a substrate;
b. a NO oxidation catalyst containing platinum and palladium on a support selected from alumina and ceria;
c. a cold-start catalyst containing palladium on a zeolite support;
wherein the NO oxidation catalyst and cold-start catalyst are washcoated onto the substrate.

2. The catalyst article of claim 1, wherein the zeolite of the cold-start catalyst is chabazite.

3. The catalyst article of claim 2, wherein the cold-start catalyst further contains beta zeolite.

4. The catalyst article of claim 3, wherein the beta zeolite is unmodified.

5. The catalyst article of claim 4, wherein the palladium zeolite and the unmodified beta zeolite are washcoated onto the substrate as a physical mixture.

6. The catalyst article of claim 1, wherein the cold-start catalyst is washcoated on the entire length of the substrate.

7. The catalyst article of claim 1, wherein the NO oxidation catalyst support is alumina.

8. The catalyst article of claim 1, wherein the NO oxidation catalyst support is ceria.

9. The catalyst article of claim 1, wherein the substrate is a flow-through monolith or a wall-flow filter.

10. The catalyst article of claim 1, wherein the cold-start catalyst consists essentially of palladium on a zeolite support and one or more additional components selected from binders and stabilizers.

11. The catalyst article of claim 1, wherein the NO oxidation catalyst consists essentially of platinum and palladium on a support selected from alumina and ceria and one or more additional components selected from alumina, ceria, binders, and stabilizers.

12. The catalyst article of claim 10, wherein the NO oxidation catalyst consists essentially of platinum and palladium on a support selected from alumina and ceria and one or more additional components selected from alumina, ceria, binders, and stabilizers.

13. The catalyst article of claim 10, wherein the NO oxidation catalyst consists essentially of platinum and palladium on a support selected from alumina and ceria and one or more additional components selected from binders and stabilizers.

14. The catalyst article of claim 1, wherein the cold-start catalyst is washcoated on the support and the NO oxidation catalyst is washcoated on the cold-start catalyst.

15. The catalyst article of claim 1, wherein the NO oxidation washcoated on the substrate has a Pt loading of 17.5 to 100 g/ft³ and a Pd loading of 35 to 100 g/ft³.

16. The catalyst article of claim 1 further comprising an oxidation catalyst containing platinum and palladium supported on one of alumina or ceria.

17. The catalyst article of claim 16 wherein the oxidation catalyst is a diesel oxidation catalyst.

18. The catalyst article of claim 1, wherein the article has a NOₓ storage capacity of at least 0.14 g NO₂/L at 80 deg. C.
